(19) United States
(12) Patent Application Publication
(10) Pub. No.: US 2012/0209455 A1
(43) Pub. Date: Aug. 16, 2012

(54) Autopilot with Adaptive Rate/Acceleration Based Damping

(76) Inventor: Edward J. Warkomski, Tucson, AZ (US)

(21) Appl. No.: 13/024,514

(22) Filed: Feb. 10, 2011

(51) Int. Cl. G05D 1/08

(52) U.S. Cl. 701/3; 244/3.1

(57) ABSTRACT

A control system includes a rate-damping loop that uses a motion parameter error (heading pitch, heading yaw, attitude pitch, attitude yaw, and attitude roll) to non-linearly scale a rate-feedback signal so that at lower motion parameter error values, an acceleration feedback term plays a greater role in pitch compensation, while at greater motion parameter error values, a rate-feedback term plays a greater role in the pitch compensation. In some embodiments, a control system and method of controlling a motion parameter of a moving body are provided. A signal representing a motion parameter error is non-linearly combined with a signal representing a rate-of-change of a motion parameter (or body angle) to generate a non-linear rate-damping signal. The non-linear rate-damping signal is subtracted from the signal representing the motion parameter error to generate a signal to control one or more elements of the moving body.

### STATEMENT REGARDING FEDERALLY SPONSORED RESEARCH OR DEVELOPMENT

This invention was made with United States government support under Contract number N00024-03-C-6111 with the Department of the Navy. The United States Government has certain rights in this invention.

### FIELD OF THE INVENTION

Embodiments of the present invention pertain to guidance and flight-control systems for moving bodies such as aircraft, spacecraft, missiles, and guided projectiles, and to methods for controlling headings for such systems.

### BACKGROUND

Conventional autopilot systems are used to control inertial orientations (e.g., pitch and yaw) of an aircraft or missile. One problem with conventional autopilot systems is that linear and nonlinear control schemes often require gain scheduling as a function of many state variables, in order to achieve adequate performance and stability.

U.S. Pat. No. 7,043,345, assigned to the same assignee as the present invention and hereby incorporated by reference, describes a control system used for real time adjustment of angle of attack as a function of vehicle state. Angle of attack is the angle between the body longitudinal axis and the flight path vector of the aircraft or missile (e.g. direction of flight). The angle of attack is adjusted in real time to achieve vehicle control and drag minimization over a wide range of mach numbers and turbulence levels.

### SUMMARY

The present inventor has recognized that the control strategy of the U.S. Pat. No. 7,043,345, intended for angle of attack control, can be beneficially applied to tasks having nothing to do with the aerodynamic drag minimization and, more particularly, to the task of controlling vehicle motion parameters, being any of heading (pitch or yaw), or attitude (pitch, yaw and roll) for autopilot systems. Generally, the invention provides an autopilot system which includes a rate-damping loop that uses a received control parameter angle error (being a difference between a desired control parameter (e.g. heading or attitude parameter) from a navigational system and actual values of these parameters to non-linearly scale a rate-feedback signal, so that at lower control parameter error values an acceleration feedback term may play a greater role in pitch compensation, while at greater control parameter error values, a rate-feedback term may play a greater role in the pitch compensation; i.e. adaptive control based upon a self-regulating tuner which adjusts to the specific state of the instantaneous vehicle flight dynamics.

In some embodiments, a method of controlling a motion parameter of a moving body is provided. The method comprises non-linearly combining a signal representing a control parameter error with a signal representing a rate-of-change of a control parameter to generate a non-linear rate-damping signal. The non-linear rate-damping signal is subtracted from the signal representing the control parameter error to control one or more elements of the moving body. The control parameter error may be a measure of heading parameters of pitch or yaw or attitude parameters of pitch, yaw or roll.

In some embodiments, a control system for controlling motion parameters for a moving body is provided. The control system comprises a non-linear combining circuit element, which is part of a non-linear rate-damping loop, for non-linearly combining a signal representing a control parameter error with a signal representing a rate-of-change of control parameter to generate a non-linear rate-damping signal. The control system also comprises a subtraction circuit element for subtracting the non-linear rate-damping signal from the signal representing the control parameter error to generate a signal for controlling one or more elements of the moving body.

In some embodiments, a product of the signal representing the motion parameter error and the signal representing a rate-of-change of the control parameter may be raised to an exponent to generate the non-linear rate-damping signal. In some embodiments, a second derivative of the control parameter error may also be used to control one or more elements of the moving body. In some embodiments, the control parameter may be subtracted from a desired control parameter to generate the signal representing the control parameter error.

In some embodiments, the present invention provides an airframe. The airframe may be part of an aircraft, a spacecraft, a missile, an Unmanned Air System (UAS) or a guided projectile. In these embodiments, the airframe comprises a control system to control a flight parameter by non-linearly combining a signal representing a flight parameter error with a signal representing a rate-of-change of a motion parameter to generate a non-linear rate-damping signal. The control system may subtract the non-linear rate-damping signal from the signal representing the flight parameter error to generate a signal to control one or more elements of the airframe. In these embodiments, the airframe may also comprise an airframe-state estimator which generates, among other things, the flight parameter and the rate-of-change of the flight parameter from sensors.

### BRIEF DESCRIPTION OF THE DRAWINGS

The appended claims are directed to some of the various embodiments of the present invention. However, the detailed description presents a more complete understanding of embodiments of the present invention when considered in connection with the figures, wherein like reference numbers refer to similar items throughout the figures and:

FIG. 1 illustrates an airframe within a coordinate system in accordance with embodiments of the present invention;

FIG. 2 illustrates an airframe within a pitch-plane coordinate system in accordance with embodiments of the present invention;

FIG. 3 illustrates an airframe within a yaw-plane coordinate system in accordance with embodiments of the present invention; and

FIG. 4 illustrates an airframe within a roll-plane coordinate system in accordance with embodiments of the present invention;

FIG. 5 is a functional block diagram of a control system along with other system elements in accordance with embodiments of the present invention;

FIG. 6 is a flow chart of a procedure for controlling motion parameters in accordance with embodiments of the present invention;

### DETAILED DESCRIPTION

The following description and the drawings illustrate specific embodiments of the invention sufficiently to enable those skilled in the art to practice them. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of embodiments of the invention encompasses the full ambit of the claims and all available equivalents of those claims.

In embodiments, the control systems and methods of the present invention may provide for improved control of airframe flight parameter error. In these embodiments, the acceleration feedback term of a control parameter angle plays a greater role in control parameter compensation at lower control parameter error angles, while allowing the rate-feedback term of the control parameter angle to play a greater role in the control parameter compensation at greater control parameter error angles. In some embodiments, the control systems and methods of the present invention may also significantly reduce control system activation duration thereby reducing trim drag and battery drain or power consumption. In some embodiments, the control systems and methods of the present invention may also provide for more accurate control of the steady-state control parameter over a wider range of feasible system rise times, overshoot levels, and body rates.

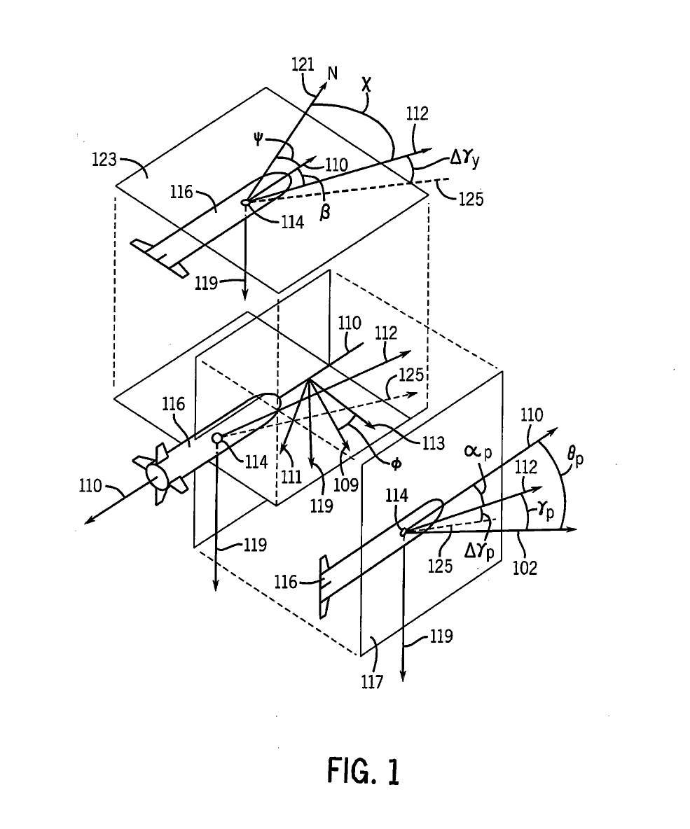

FIGS. 1-4 illustrate an airframe within a coordinate system in accordance with embodiments of the present invention. Coordinate system 100 illustrates moving body 116 having center-of-gravity 114 moving in a direction of flight-path vector 112 (v-msl). The direction of flight-path vector 112 may decompose into a pitch component γp measured between the flight-path vector 112 and a reference such as the horizon 102 (xᵢ) in a vertical plane 117 holding a gravitational vector 119 and an acceleration vector 110 (x_{b}) of the body 116, and a yaw component χ measured between the flight-path vector 112 and a reference such as geographic north 121 (x-inertial) in a horizontal plane 123 normal to the gravitational vector 119 (zᵢ) and holding the acceleration vector 110 of the body 116.

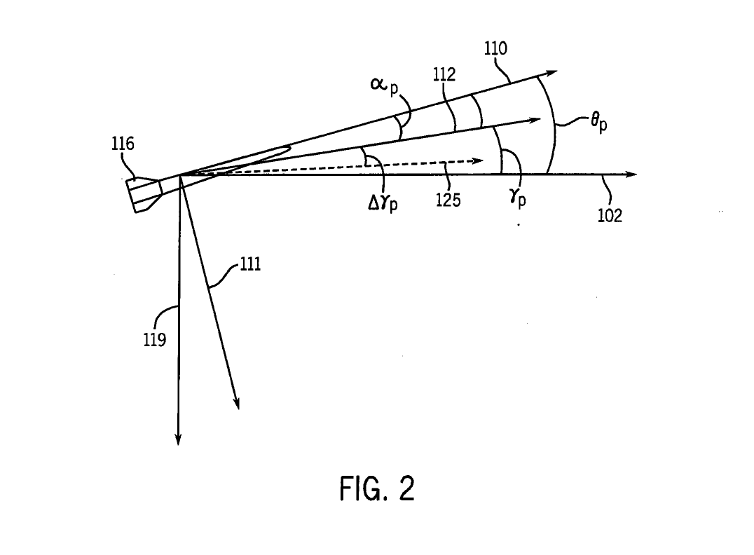

FIG. 2 illustrates a moving body 116 in a pitch-plane coordinate system, having an acceleration vector 110, a flight-path vector 112, a horizon 102, and a desired flight path 125. Further illustrated in FIG. 2 are a gravitational vector (i.e. inertial vector) 119 oriented perpendicularly to the horizon 102 and a body vector 111 (z_{b}) oriented perpendicularly to the acceleration vector 110.

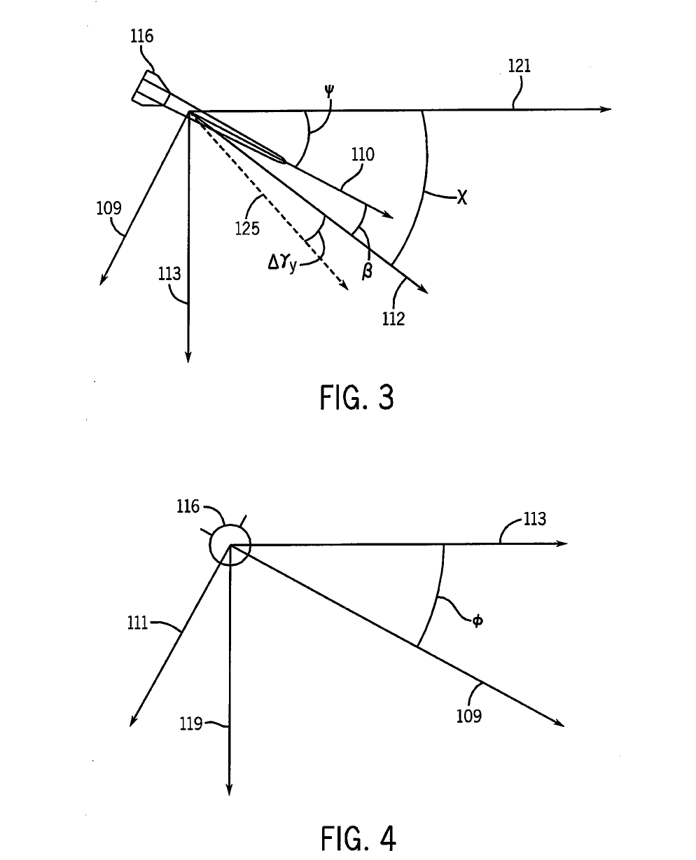

FIG. 3 illustrates a moving body 116 in a yaw-plane coordinate system, having an acceleration vector 110 (x-body), a flight-path vector 112, a reference such as geographic north 121, and a desired flight path 125. Further illustrated in FIG. 3 are a lateral inertial vector 113 (y-inertial) oriented perpendicularly to the geographic north 121 and a body vector 109 (y-body) oriented perpendicularly to the acceleration vector 110.

FIG. 4 illustrates a moving body 116 in a roll-plane coordinate system, having are a gravitational vector (i.e. inertial vector) 119 oriented perpendicularly to the horizon (not shown) and a lateral inertial vector 113 (y-inertial) oriented parallel to the horizon. Further illustrated in FIG. 4 are body vector 111 (z-body) and a body vector 109 (y-body) oriented perpendicularly to one another. Angle φ is measured between lateral inertial vector 113 and body vector 109 with respect to the body 116 about the acceleration vector 110 within a plane generally orthogonal to the pitch and yaw planes described above.

A desired flight path 125, produced by a navigational system holding a stored set of waypoints, for example, may be compared to the flight-path vector 112 to produce a corresponding heading error angle 108 in each of pitch and yaw designated as Δγₚ and Δχ respectively.

A body angle (e.g., theta (θ)), readily measured by onboard instrumentation, may be defined between the acceleration vector 110 and a fixed reference such as geographic north or the horizon and decomposed into pitch and yaw, respectively, as θₚ and ψ. Angle of attack (e.g., alpha (α)) between the acceleration vector 110 and the flight-path vector 112 is shown for reference but not used in the present invention. Similarly, yaw angle (e.g., beta (β)) between the acceleration vector 110 and the flight-path vector 112 is shown for reference but not used in the present invention.

A body roll (e.g., phi (φ)) is readily measured by onboard instrumentation between a gravitational vector 119 and an arbitrary reference angle 115 fixed with respect to the body 116 about the acceleration vector 110 within a plane generally orthogonal to the planes of θ described above.

Moving body 116 may be an airframe or other moving body including aircraft, spacecraft, missiles, unmanned aerial vehicles (UAVs) and guided projectiles. In some embodiments, moving body 116 may be a ground based moving vehicle such as an automobile.

In accordance with embodiments of the present invention, control systems and methods of controlling control parameter error angles of moving body 116 are provided. In some embodiments, a control system includes a rate-damping loop that uses a calculated control parameter error to non-linearly scale a rate-feedback signal so that at lower control parameter error values an acceleration feedback term plays a greater role in pitch compensation, while at greater control parameter error values the rate-feedback term plays a greater role in the pitch compensation. This is described in more detail below.

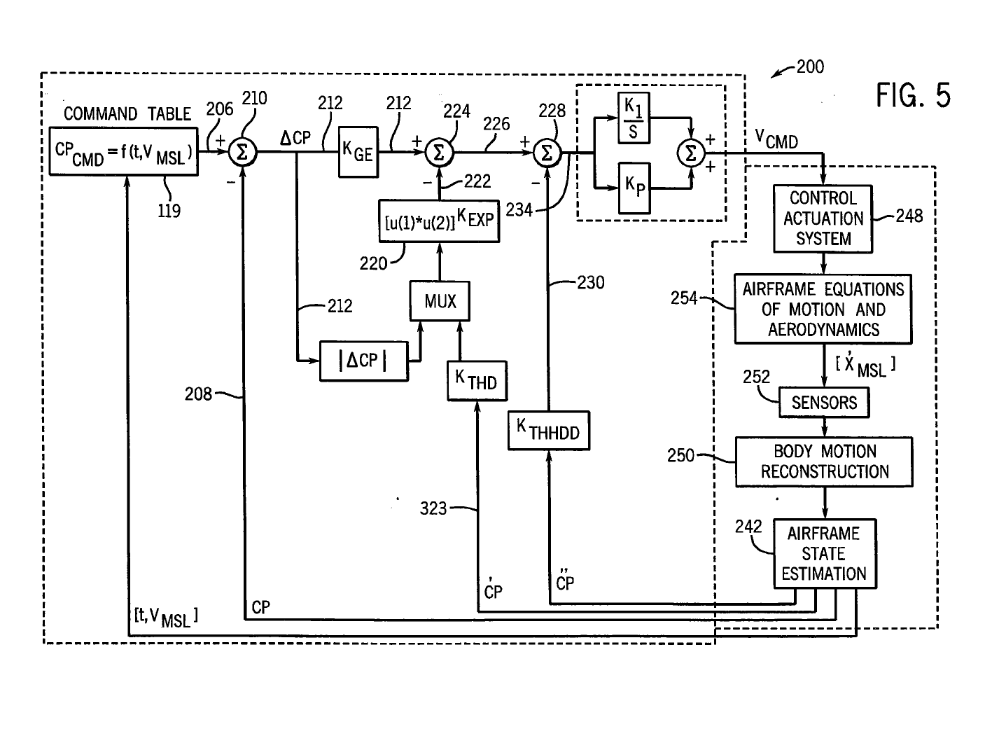

FIG. 5 is a functional block diagram of a control system along with other system elements in accordance with embodiments of the present invention. Control system 200 and system elements 240 may be part of any moving body, such as moving body 116 (FIG. 1), which may have guidance and/or control systems to assist with flight control. In general, control system 200 receives airframe-state estimates from system elements 240 for use by control system 200 as part of one or more feedback loops to generate control signal 238. The control signal may be used by system elements 240 for motion parameter control including heading pitch or yaw and/or attitude pitch, yaw, or roll.

The depicted control system 200 can be used for the control of a variety of heading and attitude parameters (collectively motion parameters) by considering corresponding control parameters (CP) for any single row of Table I as provided below:

TABLE I

| | control | control parameter | first | second |
|---|---|---|---|---|
| motion parameter | parameter | error | derivative | derivative |
| (CP_{cmd}) | (CP) | (ΔCP) | [symbol] | [symbol] |
| heading: pitch | γₚ | Δγₚ | [symbol] | [symbol] |
| heading: pitch | γₚ | Δγₚ | [symbol] | [symbol] |
| (alternative) | | | | |
| heading: yaw | χ | Δχ | [symbol] | [symbol] |
| heading: yaw | χ | Δχ | [symbol] | [symbol] |
| (alternative) | | | | |
| attitude: | θₚ | Δθₚ | [symbol] | [symbol] |
| pitch | | | | |
| attitude: | ψ | Δψ | [symbol] | [symbol] |
| yaw | | | | |
| attitude: roll | φ | Δφ | [symbol] | [symbol] |

Separate control loops may be established for each of these different motion parameters (selecting from one alternative) for simultaneous control.

The control system 200 receives a desired control parameter 206 (CP_{cmd}) from a navigational sequence generator 199. The desired control parameter 206 may be received by subtraction circuit element 210 for subtracting actual control parameter 208 (CP) from desired control parameter 206 to generate signal 212 to represent the control parameter error angle (ΔCP).

Control system 200 may include non-linear combining circuit element 220 to non-linearly combine a magnitude of signal 212 representing a control parameter error angle with signal 232 representing a rate-of-change of control parameter 208 providing second derivative control parameter (ĊP) to generate signal 222. Note that for control parameters related to heading (pitch or yaw), rate-of-change of attitude (pitch or yaw) may serve as a proxy for the rate-of-change (first or second derivative) control parameter as shown by the “alternative” rows in Table I.

Signal 222 may be viewed as a non-linear rate-damping signal. Control system 200 may include subtraction circuit element 224 to subtract signal 222 from signal 212′ to generate signal 226 for use in controlling one or more system elements of the moving body.

In some embodiments, control system 200 may include subtraction circuit element 228 to subtract signal 230 representing a rate-of-change of signal 232 from signal 226 providing the second derivative control signal (\ddot{C}P) to generate control signal 234 for controlling one or more elements 240 of the moving body. In some cases, control signal 234 may be used to control one or more elements of the moving body to affect pitch or yaw of the moving body.

In some embodiments, non-linear combining circuit element 220 may raise a product of signals 212 and 232 (illustrated as the product of signals u1 and u2) to an exponent to generate signal 222, although the scope of the invention is not limited in this respect. The exponent may range from 0.1 to up to 10 and greater depending on system elements including the various weighting values.

In some embodiments, system 200 may further comprise compensation circuit element 236 to apply proportional-plus-integral (P+I) compensation to control signal 234 to generate a command signal which may be command voltage 238.

In some embodiments, control system 200 may include multiplication circuit element 214 to scale and/or multiply signal 212 by a first weighting value (e.g., KGE) prior to subtracting signal 222 from signal 212 in circuit element 224. Control system 200 may also include multiplication circuit element 246 to scale and/or multiply signal 232 by a second weighting value (e.g., KTHD) prior to non-linearly combining signals 232 and 212 in circuit element 220. Control system 200 may also include multiplication circuit element 244 to scale and/or multiply signal 230 by a weighted value (e.g., KTHDD) prior to subtracting signal 230 from signal 226 in circuit element 228. The weighting values may be predetermined during system alignment or may be dynamically adjusted. The weighting values may range from 0.1 to up to 100 and even greater. In embodiments, the weighting values may be initially estimated based on a particular airframe or system and then tuned.

In some embodiments, control system 200 may include absolute-value circuit element 216 to provide the magnitude of signal 212 prior to non-linearly combining with signal 232 in circuit element 220. In some embodiments, control system 200 may include multiplexer circuit element (MUX) 218 to multiplex signals 212 and 232 prior to the operation of non-linear combining circuit element 220.

In some embodiments, signals 212, 232, 222, 226, and 230 may comprise vectors, and the first, second and third weighted values may be scalars having predetermined values. The values may be selected based on airframe and system characteristics. In embodiments, the values may be initially estimated based on a particular airframe or system, and then tuned and further adjusted.

Signal 222 may be a non-linear rate-damping signal that is generated as part of a rate-damping loop and may represent a non-linearly weighted rate-of-change of the control parameter. Signal 226 may be an error signal that includes the non-linearly weighted effect of the rate-damping signal. Signal 230 may represent the rate-of-change of the body angle 104, the rate-of-change of signal 232 (e.g. approximating a second derivative of signal 208) or the acceleration of control parameter 208 (represented by the second derivative of body angle 104) that may be generated as part of an acceleration-damping loop.

Control system 200 may receive control parameter 208, signal 232 and signal 230 from airframe-state estimator 242, which may be part of system elements 240. In some embodiments, airframe-state estimator 242 may receive input from body motion reconstruction element 250 which reconstructs the motion of an airframe from input provided by sensors 252. Airframe equations of motion and aerodynamics elements 254 may generate input from sensors 252. In some embodiments, the airframe state estimations from airframe-state estimator 242 may be computed from data received by aircraft state sensors 252 such as gyros, rate gyros, control fin position, seeker gimbal angle and angle rate, and inertial measurement units (IMUs). Different airframes may have a different set of sensors depending on size and cost. System elements 240 may use the data from sensors 252 along with known information from airframe equations of motion and aerodynamics elements 254 to determine current airframe body motion, which may then be transformed into body angles and rates information.

The control signal (e.g., signal 234 or command voltage 238 (e.g., V_{CMD})) provided by control system 200 may be used by system elements 240, such as actuator system 248 for, among other things, pitch or yaw control. Because the rate-damping loop uses a calculated control parameter angle error (e.g., signal 212) to non-linearly scale rate-feedback signal 232, an acceleration-feedback term (e.g., signal 230) may play a greater role in pitch or yaw adjustment at lower control parameter error values, while at greater control parameter error values, a rate-feedback term (e.g., signal 232) may play a greater role in the pitch or yaw compensation.

Although control system 200 and system elements 240 are illustrated as having several separate functional and circuit elements, one or more of the functional and circuit elements may be combined and may be implemented by combinations of hardware and software-configured elements, such as processing elements including digital signal processors (DSPs), and/or other hardware elements. For example, in some embodiments, subtraction circuit elements 210, 224 and 228, multiplication circuit elements 214, 244 and 246, non-linear combining circuit element 220, absolute-value circuit element 216 and multiplexer circuit element 218 may be comprised of logic circuitry and/or firmware, while in other embodiments, these functional elements may be comprised of software-configured elements including processing elements. Processing elements may comprise one or more microprocessors, DSPs, application specific integrated circuits (ASICs), and combinations of various hardware and logic circuitry for performing at least the functions described herein.

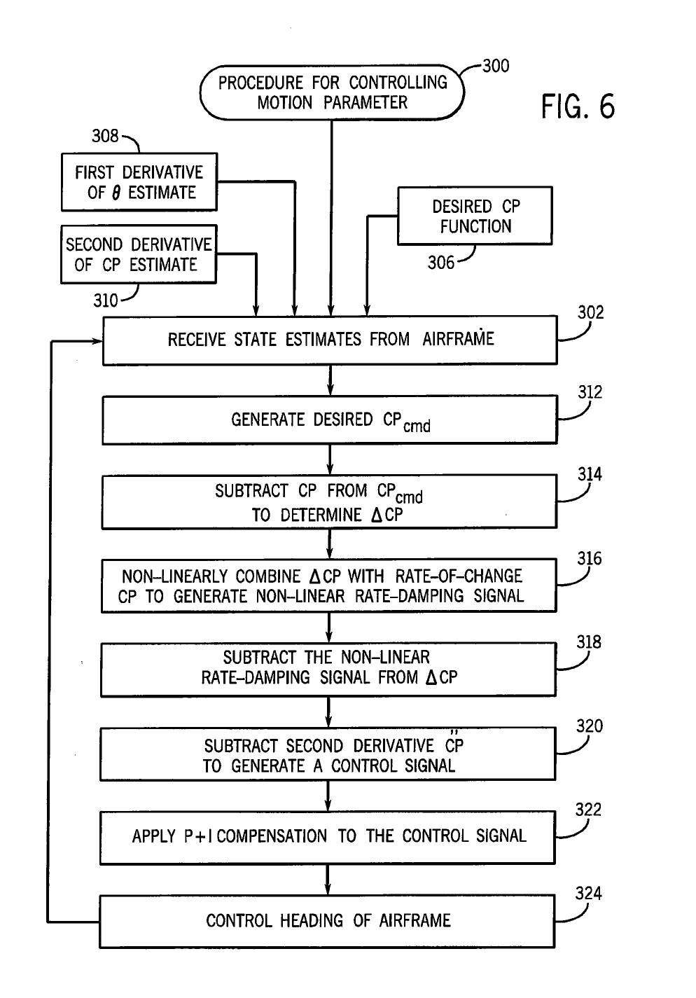

FIG. 6 is a flow chart of a procedure for controlling control parameter in accordance with embodiments of the present invention. Procedure 300 may be performed by a control system, such as control system 200 (FIG. 5), although other control systems may also be used for performing procedure 300. In general, procedure 300 may be used to help control a motion parameter of a moving body by providing a control signal which is generated based on state estimates received for the moving body.

Operation 302 receives state estimates from an airframe-state estimator and from the navigational sequence generator 199. The state estimates may include a desired control parameter 306, which may correspond to control parameter 206 (FIG. 5), first derivative 308 of the control parameter which may correspond to signal 232 (FIG. 5), and second derivative 310 of the control parameter which may correspond to signal 230 (FIG. 5).

Operation 312 generates a desired control parameter from a time value and the desired control parameter function of navigational sequence generator 199 which may correspond to desired control parameter 206 (FIG. 52). Operation 312 may, for example, utilize a waypoint table or stored map system or real time telemetry to generate the desired control parameter. Operation 314 subtracts the control parameter from the desired control parameter to determine a control parameter error angle, which may correspond to signal 212 (FIG. 5).

Operation 316 may non-linearly combine the signal representing the control parameter error angle with the signal representing the rate-of-change of the body angle (e.g., first derivative 308) to generate a non-linear rate-damping signal, which may correspond to signal 222 (FIG. 5). Operation 318 subtracts the non-linear rate-damping signal from the signal representing the control parameter error to generate a signal which may be an error signal that includes a weighted effect of the rate-damping signal. In some embodiments, this signal may be used to control the pitch or yaw of a moving body. The signal generated by operation 318 may correspond to signal 226 (FIG. 5).

In some embodiments, operation 320 subtracts the signal representing a rate-of-change of second derivative 310 from the signal generated in operation 318 to generate a control signal for use in controlling one or more elements of the moving body. The control signal generated in operation 320 may correspond to signal 234 (FIG. 5). Operation 324 may apply proportional-plus-integral (P+I) compensation to the control signal to generate a command voltage prior to use by system elements of the moving body.

As illustrated, the operations procedure 300 may be repeated and performed on a substantially continual basis as an airframe is in motion as part of a feedback system which may help keep the control parameter error minimized. Although the individual operations of procedure 300 are illustrated and described as separate operations, one or more of the individual operations may be performed concurrently and nothing requires that the operations be performed in the order illustrated.

Thus, control systems and methods have been described in which acceleration feedback of the control parameter estimate may play a greater role in pitch compensation at lower control parameter error values, while allowing the rate feedback of the control parameter estimate to play a greater role in the pitch compensation at greater control parameter error values.

It is emphasized that the Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features that are expressly recited in each claim. Rather, as the following claims reflect, inventive subject matter lies in less than all features of a single disclosed embodiment. Thus the following claims are hereby incorporated into the detailed description, with each claim standing on its own as a separate preferred embodiment.

We claim:

1. A method of controlling a motion parameter error of a moving body comprising: non-linearly combining a first signal representing an error in a control parameter angle in a measurement plane with a second signal representing a rate-of-change of the control parameter angle in the measurement plane to generate a third signal, the third signal being a non-linear rate-damping signal; and subtracting the third signal from the first signal to generate a fourth signal for controlling one or more elements of the moving body to reduce the control parameter error in the measurement plane; wherein the control parameter angle is selected from the group consisting of a heading pitch, heading yaw, attitude pitch, attitude yaw, and attitude roll.

2. The method of claim 1 further comprising subtracting a fifth signal representing a rate-of-change of the second signal from the fourth signal to generate a control signal for controlling one or more elements of the moving body.

3. The method of claim 2 wherein the error in the control parameter angle is selected from the group consisting of errors in heading pitch, in which the measurement plane is a vertical plane, and errors in heading yaw in which the measurement plane is a horizontal plane.

4. The method of claim 2 wherein the rate of change of control parameter angle is approximated by change of body angle with respect to a gravity vector.

5. The method of claim 2 wherein the error in the control parameter angle is selected from the group consisting of errors in attitude pitch, in which the measurement plane is a vertical plane, errors in attitude yaw in which the measurement plane is a horizontal plane and errors in attitude roll, in which the measurement plane is orthogonal to the vertical and horizontal planes.

6. The method of claim 5 wherein the rate of change of control parameter angle is approximated by change of body angle with respect to a gravity vector.

7. The method of claim 1 wherein non-linear combining comprises raising a product of the first and second signals to an exponent to generate the third signal.

8. The method of claim 2 further comprising applying proportional-plus-integral compensation to the control signal to control the one or more elements of the moving body.

9. The method of claim 2 wherein the error in the control parameter angle is determined from a difference between a desired heading from a navigational system and a flight-path of the moving body.

10. The method of claim 2 further comprising: multiplying the first signal by a first weighting value prior to subtracting the third signal from the first signal; multiplying the second signal by a second weighting value prior to non-linearly combining the first and second signals; and multiplying the fifth signal by a third weighted value prior to subtracting the fifth signal from the fourth signal, and wherein non-linearly combining comprises non-linearly combining an absolute value the first signal with the second signal.

11. The method of claim 10 wherein the first, second, third, fourth and fifth signals are vectors, and the first, second and third weighted values are scalars having predetermined values.

12. The method of claim 2 wherein the third signal is generated as part of a rate-damping loop, the third signal representing a non-linearly weighted rate-of-change of the control parameter angle, the fourth signal is an error signal that includes a weighted effect of the non-linear rate-damping signal, and the fifth signal represents a second derivative of the control parameter angle and is generated as part of an acceleration-damping loop.

13. The method of claim 1 wherein the moving body is an airframe comprising one of an aircraft, spacecraft, missile or guided projectile.

14. A control system for controlling motion parameter errors in a moving body comprising: a non-linear combining circuit for non-linearly combining a first signal representing an error in a control parameter angle with a second signal representing a rate-of-change of the control parameter angle to generate a third signal, the third signal being a non-linear rate-damping signal; and a subtraction circuit for subtracting the third signal from the first signal to generate a fourth signal for controlling one or more elements of the moving body;
wherein the control parameter angle is selected from the group consisting of a heading pitch, heading yaw, attitude pitch, attitude yaw, and attitude roll.

15. The control system of claim 14 wherein the subtraction circuit is a first subtraction circuit, and wherein the control system further comprises a second subtraction circuit for subtracting a fifth signal representing a rate-of-change of the second signal from the fourth signal to generate a control signal for controlling one or more elements of the moving body.

16. The control system of claim 15 wherein the non-linear combining circuit raises a product of the first and second signals to an exponent to generate the third signal.

17. The control system of claim 16 further comprising multiplication circuits which: multiply the first signal by a first weighting value prior to subtracting the third signal from the first signal; multiply the second signal by a second weighting value prior to non-linearly combining the first and second signals; and multiply the fifth signal by a third weighted value prior to subtracting the fifth signal from the fourth signal, and wherein the non-linear combining circuit non-linearly combines an absolute value of the first signal with the second signal.
